(19) United States
(12) Patent Application Publication
(10) Pub. No.: US 2016/0318272 A1
(43) Pub. Date: Nov. 3, 2016

(54) PRECURED TIRE TREAD HAVING PREPARED EDGE AND METHOD OF MAKING SAME

(71) Applicant: Bridgestone Bandag, LLC, Muscatine, IA (US)

(72) Inventor: David L. BENDER, Muscatine, IA (US)

(21) Appl. No.: 15/103,340

(22) PCT Filed: Dec. 16, 2014
(86) PCT No.: PCT/US2014/070458

§ 371 Date: Jun. 10, 2016

Related U.S. Application Data
(60) Provisional application No. 61/918,027, filed on Dec. 19, 2013.

(51) Int. Cl. B29D 30/56; B29D 30/52

(52) U.S. Cl. CPC B29D 30/56; B29D 30/52; B29D 2030/541

(57) ABSTRACT

A precured tire tread includes a top surface having a plurality of tread elements thereon, a bottom surface, a front surface, and a rear surface. At least one of the front surface and the rear surface is a roughened surface that is substantially devoid of nonstick surface agents.

### FIELD OF INVENTION

The present disclosure relates to the field of tire retreading and precured tire treads. More particularly, the present disclosure relates to the field of tire retreading, precured tire treads having a prepared edge for receiving an adhesive during a tire retreading process, and a method for making same.

### BACKGROUND

Retreading of a tire may comprise removing a worn tread from a tire casing by a buffing process. A molded, precured tread is cut to an appropriate length so that it can be wound about the tire casing with a first end abutting a second end. An adhesive is applied to the tire casing, the precured tread, or both the tire casing and the precured tread. In one embodiment, a small portion (1 to 3 inches) of the leading end of the precured tread is cut to remove any nonstick surface agents. The precured tread is then cut to the appropriate length to fit the prepared tire casing. The cut ends can then be affixed to each other with an adhesive. The cutting of the leading end of the precured tread produces scrap rubber that is recycled or otherwise disposed of.

### SUMMARY OF THE INVENTION

In one embodiment, a method of preparing a precured tire tread includes forming a green rubber mixture and extruding the green rubber mixture into a green tire tread strip having a first end and a second end. The method also includes curing the green tire tread strip to form a precured tire tread having a first end and a second end. The method further includes buffing the first end of the precured tire tread and buffing the second end of the precured tire tread.

In another embodiment, a precured tire tread includes a top surface having a plurality of tread elements thereon, a bottom surface, a front surface, and a rear surface. At least one of the front surface and the rear surface is a roughened surface that is substantially devoid of nonstick surface agents.

In yet another embodiment, a method of retreading a tire includes providing a tire casing and providing a precured tire tread having a bottom surface, a first end, and a second end. The method further includes roughening at least one of the first end and the second end of the precured tire tread. The method also includes applying a first substance to one of the tire casing and the bottom surface of the precured tire tread, and applying a second substance to one of the first end and the second end of the precured tire tread. The method further includes winding the precured tire tread around the tire casing such that the first end of the precured tire tread abuts the second end of the precured tire tread.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing of an exemplary mixing device for producing a green rubber mixture;

FIG. 2 is a schematic drawing of an exemplary extruding device for extruding a green tire tread strip;

FIG. 3 is a schematic drawing of an exemplary tire tread vulcanization mold;

FIG. 4 is a schematic drawing of one embodiment of a precured tire tread and a pair of wire rotary brushes;

FIG. 5 is a perspective view of one embodiment of roll of precured tire tread; and

FIG. 6 is a schematic drawing of a side view of a precured tire tread being applied to a tire casing.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Tread” as used herein, refers to that portion of the tire that comes into contact with the road or ground under normal inflation and load.

While similar terms used in the following descriptions describe common tire components, it should be understood that because the terms carry slightly different connotations, one of ordinary skill in the art would not consider any one of the following terms to be purely interchangeable with another term used to describe a common tire component.

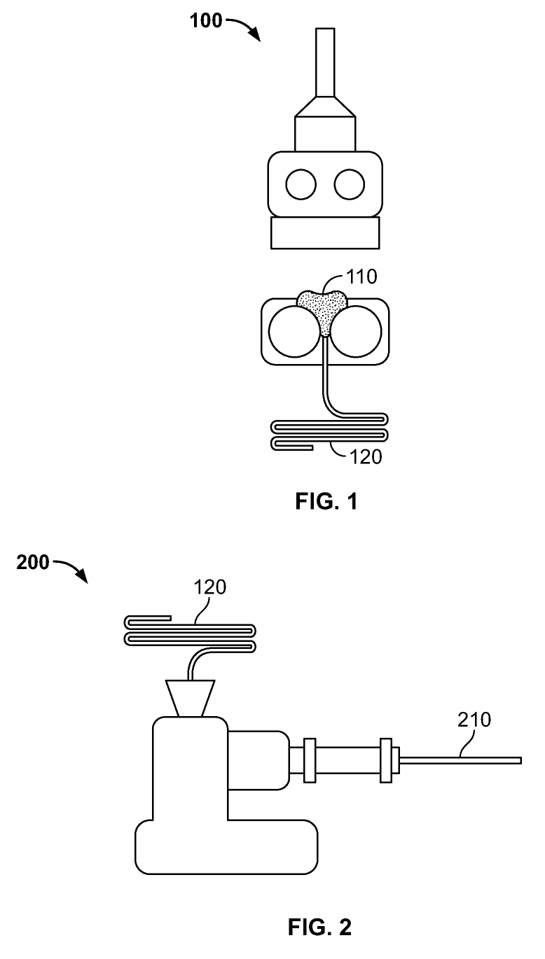

FIGS. 1-4 are schematic illustrations of different stations in a system for preparing a precured tire tread. FIG. 1 is a schematic drawing of an exemplary mixing device 100 for receiving one or more compounds 110. The mixing device 100 mixes the one or more compounds 110 to produce a green rubber mixture 120. The details of mixing devices are known in the art and are not repeated here.

The green rubber mixture 120 is fed into an extruding device, such as the exemplary extruding device 200 shown schematically in FIG. 2. The extruding device 200 extrudes the green rubber mixture 120 into a continuous green strip 210 that is cut to the appropriate size for preparing the cured tire tread. The green tire tread strip has a first end and a second end. The details of extruding devices are known in the art and are not repeated here.

In the illustrated embodiment, the mixing device 100 and the extruding device 200 are shown as separate machines. In an alternative embodiment (not shown), a single machine may function as both a mixing device and an extruding device.

In an alternative embodiment, the green tire tread strip may be formed by a 3D printing or additive manufacturing process. In such an embodiment, the mixing device and extruding device may be omitted.

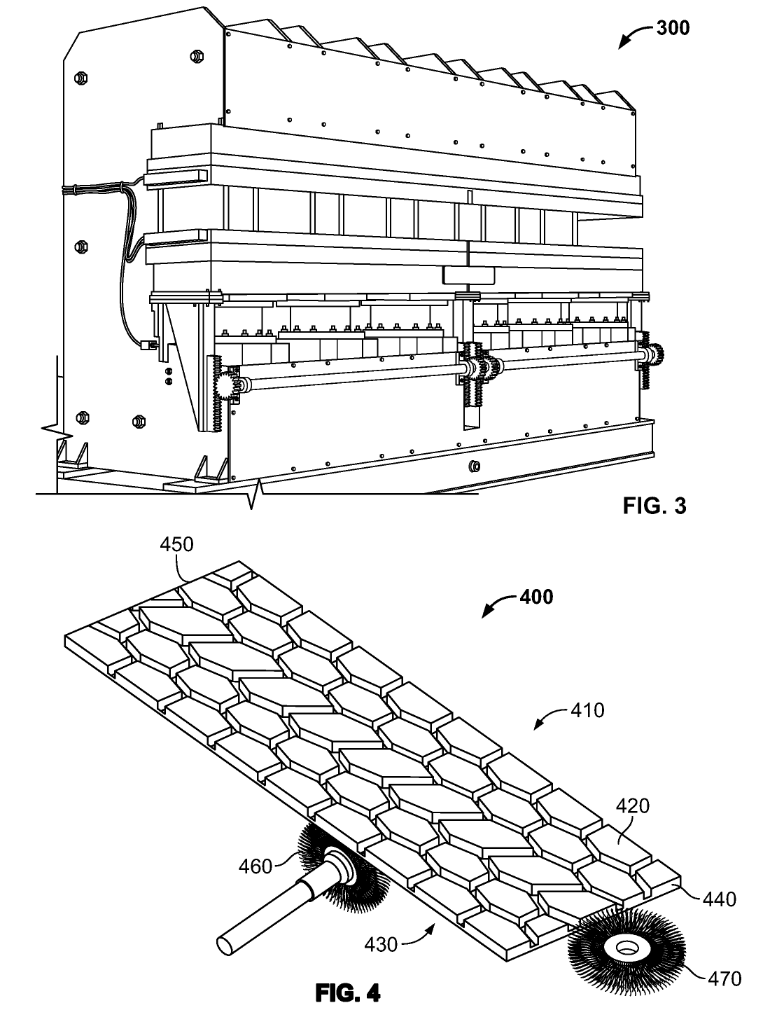

The green tire tread strip is placed in a tread vulcanization mold, such as the exemplary tire tread vulcanization mold 300 illustrated in FIG. 3. The green tire tread strip may be cut to an appropriate length according to the dimensions of the tread vulcanization mold 300. In one known embodiment, the green tire tread strip is cut to a length of approximately 30 feet (9 meters). However, it should be understood that the green tire tread strip may be cut to any desired length. The tire tread vulcanization mold 300 cures the green tire tread strip by applying heat and pressure, thereby forming a precured tire tread having a first end and a second end. In one embodiment, the tire tread vulcanization mold 300 applies heat of about 350° F. (180° C.) with pressures of about 350 PSI (2400 kPa). In alternative embodiments, the tire tread vulcanization mold 300 applies heat of about 300-370° F. (150-190° C.) with pressures of about 200-850 PSI (1370-5800 kPa). The details of tire tread vulcanization molds are known in the art and are not repeated here.

Alternatively, the precured tire tread may be formed by a 3D printing or additive manufacturing process. In such an embodiment, although the step of curing a green tire tread strip in a tire tread vulcanization mold would be omitted, the resulting tire tread may still be referred to as “pre-cured,” because it has physical properties similar to that of a tire tread that has been cured in a tire tread vulcanization mold, or because a full curing process is unnecessary.

FIG. 4 is a schematic drawing of one embodiment of a precured tire tread 400. The precured tire tread 400 includes a top surface 410 having a plurality of tread elements 420 thereon. In the illustrated example, the tread elements are a plurality of lugs separated by a plurality of grooves. In alternative embodiments, the tread elements may include ribs, bars, and blocks as well as additional grooves, sipes, and other tread elements.

The precured tire tread 400 also includes a bottom surface 430, a front surface 440, and a rear surface 450. While the example precured tire tread 400 is shown as having a generally rectangular cross-section, it should be understood that the cross-section may be generally trapezoidal or include any number of straight or curved surfaces.

To prepare the precured tire tread 400 to be affixed to a tire casing, one or more surfaces may be buffed or roughened to remove nonstick surface agents. In one embodiment a first wire rotary brush 460 is used to roughen the bottom surface 430 and a second wire rotary brush 470 is used to roughen the front surface 440. The second wire brush 470 may also be used to roughen the rear surface 450. In an alternative embodiment (not shown), a third wire rotary brush may be employed to roughen the rear surface. In another alternative embodiment (not shown) only a single brush is employed. The single brush may be employed to only roughen a single surface. Alternatively, the single brush may be used to roughen multiple surfaces. It should be understood that other devices may be used to buff or roughen the surfaces of the precured tire tread. Buffing devices may include, without limitation, Abrasive laden grinding wheels, rasps, and the like.

In one embodiment, the buffing or roughening devices are manually operated devices. In an alternative embodiment, the buffing or roughening devices are automated devices.

The resulting precured tire tread 400 has at least one surface that is substantially devoid of nonstick surface agents. For this reason, the buffing or roughening of the surface will make the use of an adhesive more effective on the prepared surface.

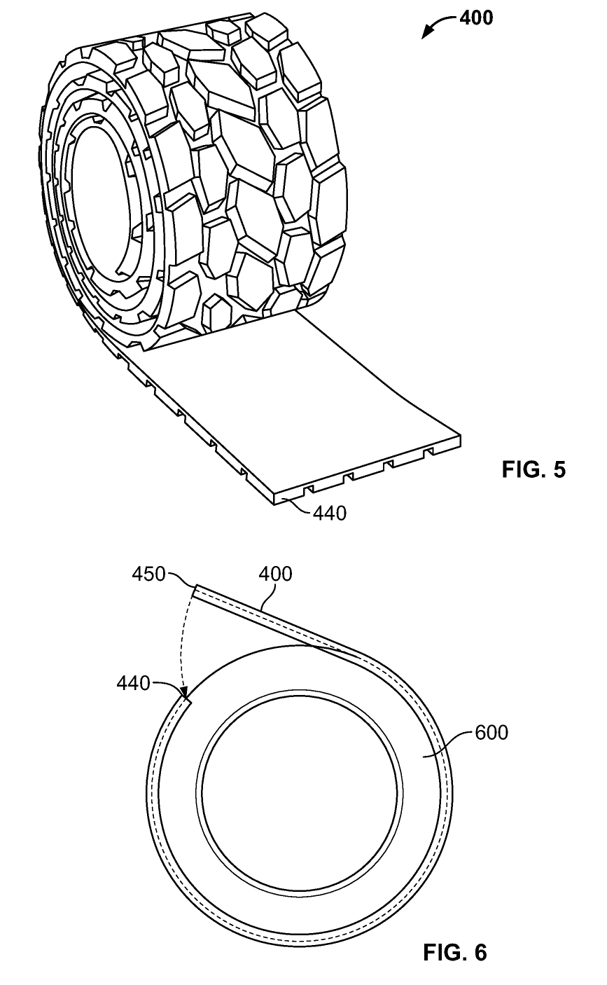

In one embodiment, the precured tire tread 400 is rolled in the manner shown in FIG. 5, such that the front surface 440 is exposed. As one of ordinary skill in the art would understand, in some instances it may be easier to transport a rolled precured tire tread than a flat precured tire tread. In other instances, it may be preferable to leave the precured tire tread in a flat formation.

Because the front surface 440 remains exposed after the precured tire tread 400 has been rolled, the step of buffing or roughening the front surface 440 may be performed after the precured tire tread 400 has been rolled.

The precured tire tread 400 may be used in a retreading process. FIG. 6 illustrates a side view of a tire casing 600 receiving a portion of the precured tire tread 400. In one embodiment, the tire casing 600 has an existing tread that is partially worn. In such cases, the existing tread may be buffed to a desired height.

In one embodiment, the retreading process includes applying an adhesive to the tire casing 600, the bottom surface 430 of the precured tire tread 400, or to both the tire casing 600 and the bottom surface 430 of the precured tire tread 400. Exemplary adhesives include, without limitation, Materials with compositions based on elastomers such as natural or synthetic rubbers or blends of such polymers. In addition, the adhesives may be based on materials such as urethanes, epoxies, and acrylates. Further, the adhesives may be based on the curatives or activating agents of the above.

In an alternative embodiment, the retread process includes applying a cement to the tire casing 600, the bottom surface 430 of the precured tire tread 400, or to both the tire casing 600 and the bottom surface 430 of the precured tire tread 400. The cement may be to maintain contact of the components of the composite tire prior to curing.

Cements may use solvent or water as the dispersing phase for the cement materials. The solvent based cement is comprised of a specialized rubber compound that may be dissolved or suspended in an organic solvent. The water based cements may be comprised of emulsified or suspended polymers combined with suspensions or emulsions of additives.

In the case where a cement or adhesive is applied to both the tire casing 600 and the bottom surface 430 of the precured tire tread 400, the same cement or adhesive may be applied to both surfaces. Alternatively, a different cement or adhesive may be applied to each surface. For example, a first cement may be applied to the tire casing 600 and a second cement both having properties that cause them to remain in contact with the uncured rubber adhesive. Once the tire composite is assembled (using the cemented components) the bonding may take place. Such bonding may begin or occur rapidly on contact, or with the application of temperature or pressure above a threshold amount.

In any of the above described embodiments, the process may also include applying a cement or adhesive to the front surface 440 of the precured tire tread 400, the rear surface 450 of the precured tire tread 400, or both the front and rear surfaces 440, 450 of the precured tire tread 400. Exemplary adhesives include, without limitation, materials based on elastomers, elastomeric blends, or other polymers with additives to enhance adhesion properties or provide other desirable properties. In one embodiment, a strip of green rubber may be employed as the adhesive. Where a cement is used, the cement may be one of the cements described above.

In the case where a cement or adhesive is applied to both the front and rear surfaces 440, 450 of the precured tire tread 400, the same cement or adhesive may be applied to both surfaces. Alternatively, a different cement or adhesive may be applied to each surface. For example, a first cement may be applied to the front surface 440 of the precured tire tread 400 and a second cement both having properties that cause them to remain in contact with the uncured rubber adhesive. Such bonding may begin or occur rapidly on contact, or with the application of temperature or pressure above a threshold amount.

The retreading process further includes winding the precured tire tread 400 circumferentially around the tire casing 600 such that the front surface 440 of the precured tire tread 400 abuts the rear surface 450 of the precured tire tread 400. In some instances, the precured tire tread 400 may have a length that is greater than the outer circumference of the tire casing 600. In such cases, the precured tire tread 400 may be cut to a desired length. An abrasion knife may be used to cut the precured tire tread 400, such that the new rear surface is roughened. The new rear surface may also be roughened by any of the roughening methods described above.

In other instances, the precured tire tread 400 may have a length that is less than the outer circumference of the tire casing 600. In such cases, a second precured tire tread (not shown) may be inserted to fill the gap between the front surface 440 and the rear surface 450 of the precured tire tread 400. It may be necessary to cut the second precured tire tread to an appropriate length. The surfaces of the second precured tire tread may be roughened in any of the manners described above. Likewise, cements or adhesives may be applied in any of the manners described above.

After the precured tire tread 400 has been wound circumferentially around the tire casing 600, the combined tire casing 600 and precured tire tread 400 is cured in a pressure chamber (not shown). As one of ordinary skill in the art would understand, this curing process is done at relatively low temperatures and pressures, compared to the curing of a green tire. In one embodiment, the combined tire casing 600 and precured tire tread 400 is cured at a temperature of about 200° F. (100° C.) and a pressure of about 90 PSI (600 kPa). In other embodiments, the combined tire casing 600 and precured tire tread 400 is cored at a temperature between 200 to 300° F. (100 to 150° C.) and a pressure between 70 to 120 PSI (480 to 830 kPA).

After the curing process, the cured tire is removed and may be used on a vehicle.

It should be understood that different steps of the process described above may be performed at different locations. For example, the precured tire tread 400 may be formed at a first location and shipped to a second location that is remote from the first location. The precured tire tread 400 may then be applied to a tire casing 600 at a second location. In the above described example, the buffing or roughening steps may be performed at the first location. Alternatively, the buffing or roughening of the tread ends may be performed at the second location.

The methods and constructions described in this disclosure may also allow for rubber savings. For example, the methods and constructions described herein may reduce the amount of scrap rubber that is produced during a tire retreading process.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of preparing a precured tire tread, the method comprising:
forming a green rubber mixture;
extruding the green rubber mixture into a green tire tread strip having a first end and a second end;
curing the green tire tread strip to form a precured tire tread having a first end and a second end;
buffing the first end of the precured tire tread; and
buffing the second end of the precured tire tread.

2. The method of claim 1, further comprising rolling the precured tire tread into a roll.

3. The method of claim 1, further comprising shipping the precured tire tread to a remote location.

4. The method of claim 3, wherein the shipping the precured tire tread to a remote location is done after the buffing of the first and second ends of the precured tire tread.

5. The method of claim 3, wherein the shipping the precured tire tread to a remote location is done prior to the buffing of the first and second ends of the precured tire tread.

6. The method of claim 1, further comprising applying at least one of a cement and an adhesive to at least one of the first and second ends of the precured tire tread.

7. The method of claim 1, wherein the buffing of the first and second ends of the precured tire tread is performed with a rotary brush.

8. A precured tire tread comprising:
a top surface having a plurality of tread elements thereon;
a bottom surface;
a front surface; and
a rear surface,
wherein at least one of the front surface and the rear surface is a roughened surface that is substantially devoid of nonstick surface agents.

9. The precured tire tread of claim 8, wherein both the front surface and the rear surface are roughened surfaces that are substantially devoid of nonstick surface agents.

10. The precured tire tread of claim 9, wherein the bottom surface is a roughened surface that is substantially devoid of nonstick surface agents.

11. The precured tire tread of claim 8, wherein the bottom surface is a roughened surface that is substantially devoid of nonstick surface agents.

12. The precured tire tread of claim 8, wherein the at least one of the front surface and the rear surface is roughened by a wire brush.

13. The precured tire tread of claim 8, further comprising at least one of a cement and an adhesive disposed on at least one of the front surface, the rear surface, and the bottom surface.

14. A method of retreading a tire, the method comprising:
providing a tire casing;
providing a precured tire tread having a bottom surface, a first end, and a second end;
roughening at least one of the first end and the second end of the precured tire tread;
applying a first substance to one of the tire casing and the bottom surface of the precured tire tread;
applying a second substance to one of the first end and the second end of the precured tire tread; and
winding the precured tire tread around the tire casing such that the first end of the precured tire tread abuts the second end of the precured tire tread.

15. The method of claim 14, further comprising cutting the precured tire tread from a roll of precured tire tread.

16. The method of claim 14, wherein the first substance is the same as the second substance.

17. The method of claim 14, wherein the first substance is an adhesive.

18. The method of claim 14, wherein the first substance is a cement.

19. The method of claim 14, further comprising buffing an existing tread of the tire casing.

20. The method of claim 14, wherein the roughening at least one of the first end and the second end of the precured tire tread includes roughening both the first end and the second end of the precured tire tread.
